(19) United States
(12) Patent Application Publication
(10) Pub. No.: US 2001/0007569 A1
(43) Pub. Date: Jul. 12, 2001

(54) Time-division multiplex transmission of data bits

(76) Inventor: Gerhard Prey, Eichenau (DE)

Correspondence Address: Lerner and Greenberg, P.A., P.O. Box 2480, Hollywood, FL, 33022-2480, US

(21) Appl. No.: 09/760,411

(22) Filed: Jan. 12, 2001

(30) Foreign Application Priority Data
Jan. 12, 2000 (DE) 100 00 942.5

(51) Int. Cl. H04J 3/04; H04J 3/02

(52) U.S. Cl. 370/535; 370/498; 370/537; 370/542

(57) ABSTRACT

Data bits—in each case one bit multiplet with a predetermined number of bits per channel—are transmitted in accordance with a particular time sequence in time-division multiplex frames. According to a predetermined allocation of the channels to groups including in each case a predetermined subset of the channels, the multiplets of in each case one group are transmitted time-interleaved with respect to one another in the time-division multiplex frames. The various groups, however, are in each case transmitted successively in the frames.

### BACKGROUND OF THE INVENTION

1. Field of the Invention

The invention relates to a time-division multiplex method for transmitting data bits which are allocated to a number of channels. The data bits are transmitted in accordance with a predetermined time sequence in time-division multiplex frames at a predetermined data rate on a transmission path. The frames include in each case a number of multiplets, namely one multiplet including a predetermined number of bits for each channel.

Time-division multiplex methods of this type are used in many different ways in telecommunication engineering in particular, e.g. in a concentrator device—usually called digital line unit (DLU). In the text below, the problem to be solved by the invention, and the basic concept of the invention, will be explained in an exemplary manner with respect to a DLU in order to provide a better understanding, however it is not intended to restrict the invention to the illustrated example.

In a DLU, a number of, e.g. up to 126, similar subscriber line modules (SLMs) are provided which implement the individual subscriber line positions in the DLU. The SLMs are decentralized components of the DLU; the central processor of the DLU exchanges data with them via a central system bus, e.g. a so-called PCM bus in which the exchange of data of the individual channels which are in each case allocated to the SLMs is implemented in accordance with the time-division multiplex method. A typical topology of the configuration of the decentralized components is that of a star-shaped distribution system, which is extended over approx. 2 m, with interconnected bus distributors (BD), resulting in a multistage distribution system hierarchy with a central part (‘digital interface unit’, DIU), a number of bus distributors as intermediate-level units and a number of decentralized components, namely the SLMs as sources/sinks for the data bits. Apart from the distribution of the data (‘data receive’, DR) and the collection of data (‘data transmit’, DX), the PCM bus also supports the clocking of the data and the control of the accesses of a number of decentralized data sources such as, e.g., the SLMS to a common data channel.

In known DLUs, a system is used in which the data bits are clocked at a fixed data rate, e.g. 4.096 Mbit/s, which are divided over 64 channels of 64 kbit/s, i.e. 64 8-bit channels are used within 125 μs; thus, one bit duration is approx. 244 ns. The data processing rate has an upper limit determined by technology, such as, e.g., the topology of the distribution system and the switching technology such as, e.g., TTL technology. The circuit provided by the SLMs must be able to generate or, respectively, accept the data bursts, namely the in each case 8 bits of a time slot, at a rate corresponding to the data rate of the central system bus even though the effective useful data flow of a channel is only 64 kbit/s since each channel is only allocated one data burst in one time slot.

It should be noted that the expression “bit”, although it usually relates to binary data units in the example of the DLU, must also be understood more generally as a digital data unit in the context of this description and a data unit can thus designate digital data which are not coded in binary form.

The control of the so-called collision detection bus, the operating principle of which is shown in European Patent Application EP 0 234 355 A1 through the use of a circuit configuration including a number of transmitters, which are synchronously pulse clock-controlled, for a common transmitting channel, is particularly time-critical. Accordingly, the signal (‘collision data transmit’, CDX) set out by a decentralized component—thus an SLM in the example considered—is conducted via bus distributors to the relevant central point of the DLU and from there back to the decentralized component again, where it is checked. In this configuration, it is permissible that signals are sent simultaneously by a number of decentralized components; these then flow together (so-called collision) and result in a sum signal which is conducted back by the central unit. The signal (‘collision data receive’, CDR) reflected back to the decentralized component(s) is received again validly within one clock unit in accordance with the principle of collision detection and weighted even before the next bit is processed with the next clock unit. In the case of a collision with the transmitting process of another decentralized source, the sending of further bits is aborted due to a lack of correspondence between the own CDX signal and the received CDR signal as a result of which the transmitting process is only continued by one of the SLMs involved as described in European Patent Application EP 0 234 355 A1. It becomes clear from this that the signal run from the decentralized component to the central unit and back again must take place within the validity period of one data bit.

As can be seen from the above explanations, the data processing rate in the decentralized components is limited by the modules used which generate and send out data bits—‘data transmit’ and ‘collision data transmit’ signals—or, respectively, receive and process data bits—‘data receive’ and ‘collision data receive’ signals. In the choice of the data rate it must also be taken into consideration that predetermined tolerances with regard to e.g. pulse distortions and time delays in the distribution system and permissible time differences (so-called ‘delta times’) of the signals must also be adhered to for various points in the system to achieve correct operation.

An increase in the data rate of the time-division multiplex transmission would provide a higher data throughput due to a corresponding increase in the number of channels, but often entails considerable technical problems. Considering, for example, a PCM bus which is to be operated, instead of at a data rate of 4.096 Mbit/s, at a higher data rate, e.g. at 8.192 Mbit/s corresponding to a doubling of the channels from 64 to 128, with a DLU with multi-stage distribution systems with a length of approx. 2 m as described above, a change to this higher data rate would make much higher demands on the circuits in the peripheral components which cannot be met with the given standards. In addition, the circuits provided in the SLMs must be able to generate or, respectively, accept the data bursts, in the present example the bit octets of a time slot, at a rate corresponding to the data rate, that is to say now at 8.192 Mbit/s corresponding to a bit period of approx. 122 ns even though the useful data flow of a channel is effectively only 64 kbit/s. On the other hand, it appears to be advisable to avoid extremely fast circuits because of their disadvantageous effect on the extent of electromagnetic radiation and the increased mutual interference, quite apart from the additional cost and operating expenditure.

Generally, the data burst allocated to one channel can naturally contain another number of data bits, e.g. four or 16 bits instead of eight bits, so that generally one bit multiplet including a predetermined number of bits is allocated to each channel.

Similarly, the timing for the collision detection bus becomes problematic since the bit of the CDX signal which is to be sent must be sent out by a SLM within the validity period of a bit and must arrive there again as “reflected” bit of the CDR signal and checked for corruption. Shortening the propagation time is difficult in principle and not possible, especially with the structure and the spatial configuration of the DLU system described. This results in the problem, in this connection, that, due to the increase in the bit rate on the central bus and the associated shortening of the bit period that is to say, for example, shortened from originally 244 ns to 122 ns—the propagation time of the signals over the distribution system of the collision detection bus is greater than this bit period.

### SUMMARY OF THE INVENTION

It is accordingly an object of the invention to provide a method and a device for transmitting data bits which overcome the above-mentioned disadvantages of the heretofore-known transmission methods and devices of this general type and which allow to increase the total data rate of a central system bus in a time-division multiplex system even though limits are set—either due to technical reasons or economic reasons—on the data processing speed of the decentralized components which generate or, respectively, receive data.

With the foregoing and other objects in view there is provided, in accordance with the invention, a method for transmitting data bits, the method includes the steps of:

allocating data bits to a plurality of channels;

providing a given time sequence in time-division multiplex frames for transmitting the data bits with a given data rate on a transmission path, the time-division multiplex frames each containing a plurality of multiplets such that for each of the channels a respective one of the multiplets includes a given number of the data bits; and

transmitting, in the time-division multiplex frames, in accordance with a given allocation of the channels to groups each including a subset of the channels, the multiplets of each of the groups in a time-interleaved manner such that between respective two of the data bits of one of the multiplets of a given one of the groups there is a respective one of the data bits of each remaining one of the multiplets of the given one of the groups and such that the groups are transmitted sequentially.

In other words, the object is achieved by a a time-division multiplex method for transmitting data bits which are allocated to a number of channels, in which method the data bits are transmitted in accordance with a predetermined time sequence in time-division multiplex frames at a predetermined data rate on a transmission path, the frames in each case containing a number of multiplets, namely one multiplet including a predetermined number of bits for each channel, wherein in the frames in accordance with a predetermined allocation of the channels to groups with a predetermined subset or partial number of the channels,

the multiplets of in each case one group are transmitted time-interleaved, namely one bit each of each of the remaining multiplets of the group between two bits each of a multiplet,

but the groups are in each case transmitted successively.

Due to this solution, the object of the invention is achieved in a simple manner. The data bits can be generated in the decentralized components at a processing rate which is below the data rate of the centralized system bus and are transmitted “interleaved” on the system bus. Due to the interleaving of the bits (or digital characters) of the multiplets in each case in a group of channels, the data processing speed can be retained or even reduced in the decentralized components while the total data rate on a central bus system is distinctly increased. In particular, the invention makes it possible to retain the previously used circuit technology of the decentralized components and also the architecture of the distribution system.

In accordance with another mode of the invention, a clock signal has a clock rate corresponding to the given data rate divided by a number of the channels allocated to the subset; a transmission of the data bits is clocked with the clock signal; and the clocking of the transmission of the data bits is triggered in each of the groups of successive ones of the multiplets with a mutual offset by one clock unit corresponding to the data rate.

In accordance with yet another mode of the invention, the channels are grouped in pairs, each of the pairs including a first channel and a second channel; and the data bits of the first channel in each of the groups are clocked with a first half of the clock unit; and the data bits of the second channel in each of the groups are clocked with a second half of the clock unit.

In accordance with a further mode of the invention, the channels are grouped in channel pairs, each of the cannel pairs including a first channel and a second channel; the data bits of associated ones of the multiplets of the first channel in each of the groups are clocked with a first half of the clock unit; and the data bits of associated ones of the multiplets of the second channel in each of the groups are clocked with a second half of the clock unit.

In accordance with another mode of the invention, the data bits are transmitted on a PCM bus in octets each including eight of the data bits.

In accordance with yet another mode of the invention, the data bits are transmitted on a collision bus; and a signal of the collision bus is additionally clocked by a central component with a bus clock corresponding to the given data rate.

For the purpose of reducing electromagnetic interference radiation, it is recommended to use system clocks having low frequencies; these also allow simple or inexpensive components to be used. It is, therefore, advantageous if the transmission of the bits is clocked through the use of a clock signal, the clock rate of which corresponds to the data rate divided by the part-number of the channels in a group, but the clocking of the bits of multiplets in each case following one another in a group is triggered with mutual offset by one clock unit corresponding to the data rate.

In a preferred embodiment of the invention which is distinguished by particular simplicity and efficiency in the evaluation of the clock signals, the channels are grouped in pairs and the clocking of the bits of one channel or, respectively, of the associated multiplet in each group occurs via one clock half, and the clocking of the bits of the other channel or, respectively, of the associated multiplet occurs via the other clock half of the clock signal. This can be done, in particular, in a level-controlled manner via the high phase or the low phase or edge-controlled through the use of rising or, respectively, falling edges.

In a particularly suitable embodiment of the invention, the data bits on a PCM bus are transmitted in octets of eight bits each.

In another, just as suitable further development of the invention in which the data bits are transmitted on a collision bus, a central component advantageously additionally clocks off the signal of the collision bus through the use of a bus clock of the predetermined data rate.

With the objects of the invention in view there is also provided, a device for generating time-division multiplex signals, including:

a plurality of latches, the latches receiving burst signals, the burst signals being allocated to groups each including a respective number of the burst signals, the burst signals containing respective data bit multiplets within a period of time-division multiplex frames with a given data rate, each of the data bit multiplets including a given number of data bits;

the latches being configured such that given ones of the latches allocated to one of the groups are driven in a time-shifted manner with a relative time offset with respect to one another for a time-interleaved transmission of the data bit multiplets of the burst signals, the relative time offset of the given ones of the latches within the one of the groups being smaller than a time interval between two of the data bits of one of the multiplets;

a common multiplexer; and the latches having outputs connected to the common multiplexer.

In other words, according to the invention, a device suitable for generating time-division multiplex signals which can be transmitted in accordance with the method according to the invention is, in particular, a device in which—on the basis of a number of burst signals which in each case contain one data bit multiplet with a predetermined number of bits within predetermined time multiplex frames with a predetermined data rate—according to a predetermined allocation of the burst signals to groups with a predetermined part-number of burst signals,

the burst signals are in each case supplied to a latch, the latches of in each case one group can be driven with mutual time offset for time-interleaved transmission of the multiplets of the burst signals, the relative time offset of the latches within the relevant group being smaller than the time interval between two bits of a multiplet, and

the outputs of the latches are combined via a common multiplexer device.

This device allows the concept of the invention to be implemented in a simple manner. The architecture of existing time-division multiplex systems is not changed and, in particular, it is possible to retain the conventional circuit technology of the decentralized components. This additionally facilitates the transition during the conversion to a bus system with a higher data rate since it is not necessary to interchange all components simultaneously.

According to another feature of the invention, the latches, within a given one of the groups, are clocked by a common clock signal with a clock rate corresponding to the given data rate divided by a number of the burst signals of the given one of the groups; and the latches allocated to successive ones of the burst signals in the given one of the groups are triggered with a mutual offset by a clock period corresponding to the given data rate.

According to yet another feature of the invention, the latches are configured for processing respective two of the burst signals in each of the groups; and a first one of the latches in each of the groups is clocked by a first half of the clock period and another one of the latches is clocked by a second half of the clock period.

According to a further feature of the invention, the common multiplexer includes a plurality of common group multiplexers having group multiplexer outputs; a multiplexing device is connected to the common group multiplexers; the outputs of the latches of each one of the groups are connected to a respective one of the common group multiplexers; and the latches are clocked by a clock signal and are configured such that signals at the outputs of the latches are released by the clock signal.

For the reasons already mentioned, it is particularly advantageous in the case of the device according to the invention if, within in each case one group, the latches are clocked through the use of a common clock signal, the clock rate of which corresponds to the data rate divided by the number of burst signals of a group, but latches which are in each case allocated to successive burst signals in a group can be triggered with a mutual offset by a clock unit corresponding to the data rate.

A preferred embodiment of the device according to the invention is implemented for processing respective two burst signals in one group, where in each group one latch can be clocked by one clock half and the other latch can be clocked by the other clock half of the clock signal. In particular, the latches can be level-controlled —driven through the use of high phase or low phase—or edge-controlled—driven through the use of rising or falling edges, respectively.

It is also advantageous if the outputs of the latches of in each case one group are combined via a common group multiplexer in which the signals of the outputs of the latches can be released through the use of the clock signals for the latches, and the outputs of the group multiplexers are supplied to a multiplexer device. The latter multiplexer device can be implemented specifically in a known manner, e.g. in a bus distributor or in a central processing unit, providing for a modular configuration.

With the objects of the invention in view there is also provided, a device for obtaining burst signals from a time-division multiplex signal, including:

a plurality of latches, the latches receiving a time-division multiplex signal including, within time-division multiplex frames, data bits with a given data rate, the time-division multiplex frames containing a plurality of multiplets such that the multiplets are provided for respective ones of a plurality of burst signals, the burst signals being allocated to groups each including a number of the burst signals, and each of the multiplets including a given number of the data bits;

a respective one of the latches being allocated to a respective one of the burst signals; and

respective ones of the latches allocated to in each case one of the groups being driven with a mutual time offset with respect to one another such that, between driving two of the data bits of a given one of the multiplets of a given one of the groups, one of the data bits of each remaining one of the multiplets of the given one of the groups is driven.

In other words, as a device for obtaining a number of burst signals from a time-division multiplex signal transmitted in accordance with a method according to the invention—which contains data bits with a predetermined data rate in the time-division multiplex signal within predetermined time-division multiplex frames with a predetermined data rate, the frames in each case containing a number of multiplets, namely one multiplet with a predetermined number of bits for each burst signal—a device is particularly suitable, according to the invention, in which, according to a predetermined allocation of the burst signals to groups with a predetermined part-number of burst signals, the time-division multiplex signal is supplied to latches, one latch in each case being allocated to one burst signal, and the latches of in each case one group can be driven with mutual time offset, where one bit each of each of the remaining multiplets of the group can be driven between the driving of respective two bits each of a multiplet of the group.

According to another feature of the invention, the latches, within a given one of the groups, are clocked by a common clock signal with a clock rate corresponding to the given data rate divided by a number of the burst signals of the given one of the groups; and the latches allocated to successive ones of the burst signals in the given one of the groups are triggered offset with respect to one another by a clock period corresponding to the given data rate.

According to yet another feature of the invention, the latches are configured for processing respective two of the burst signals in each of the groups; and a first one of the latches in each of the groups is clocked by a first half of the clock period and a second one of the latches is clocked by a second half of the clock period.

The advantages and special embodiments of this device correspond to those of the above-mentioned device for generating time-division multiplex signals.

Other features which are considered as characteristic for the invention are set forth in the appended claims.

Although the invention is illustrated and described herein as embodied in a method and a device of a time-division multiplex transmission of data bits, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of the PCM bus system of the DLU according to the invention;

FIG. 2 is a timing diagram illustrating the generation of the time-division multiplex signal of the PCM bus of the DLU of FIG. 1;

FIGS. 3 and 4 are schematic circuit diagrams of the group circuits in the DLU of FIG. 1;

FIG. 5 is a block diagram with a variant of the PCM bus system; and

FIG. 6 is a block diagram of a collision detection bus system according to the invention.

### DESCRIPTION OF THE PREFERRED EMBODIMENTS

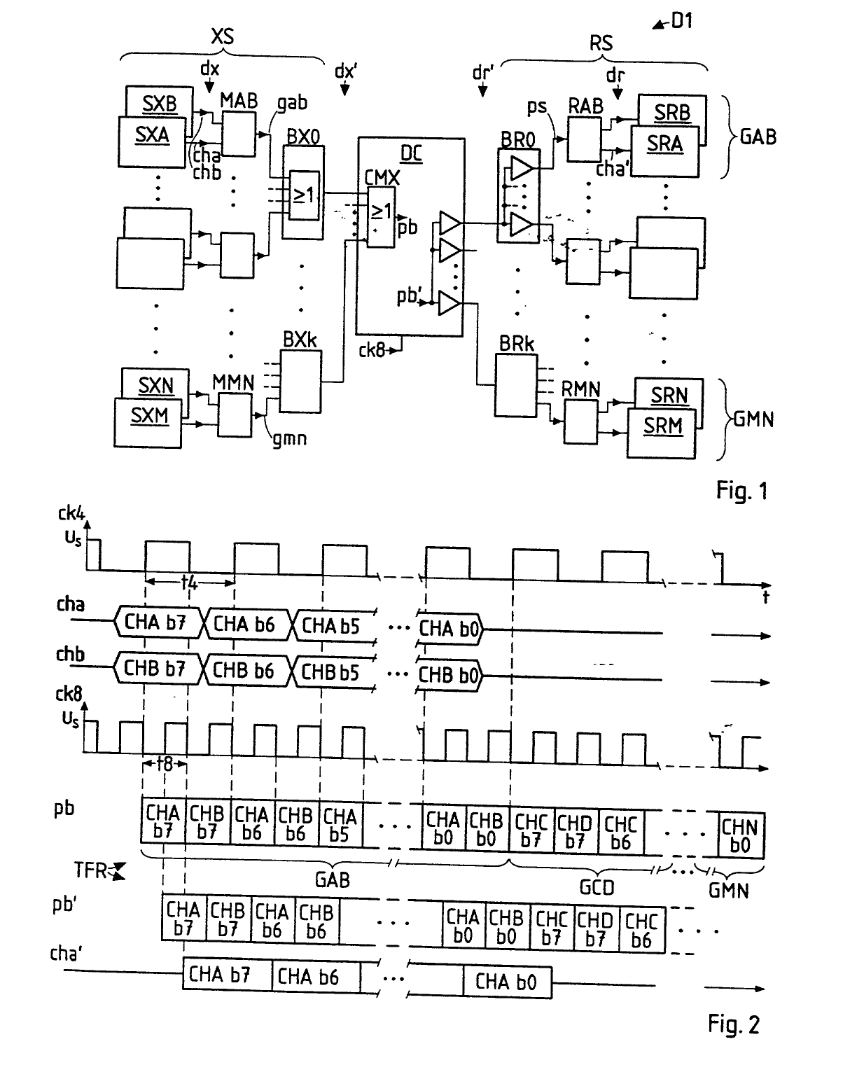

Referring now to the figures of the drawings in detail and first, particularly, to FIG. 1 thereof, there are shown the components of the PCM bus system of a DLU which are essential to the understanding of the invention. The DLU Dl exhibits a central component DC, a number of bus distributors as intermediate-level components and a number of SLM cards as decentralized components. In FIG. 1, the transmitting parts BXO,. . ., BXk and, respectively, SXA, SXB, . . . , SXM, SXN are shown on the left-hand side (transmitting components XS) and the associated receiving parts BR0, . . . , BRk and, respectively, SRA, SRB,. . ., SRM, SRN are shown on the right-hand side (receiving components RS) in each case of the bus distributors and the SLM cards.

Data are exchanged between the SLM cards via the distribution system shown in FIG. 1 which includes the bus distributor transmitting parts BX0, . . . , BXk, the central processing unit DC and the bus distributor receiving parts BR0, . . . , BRk. The so-called ‘data transmit’ signals dx sent out by the transmitting parts SXA, . . . , SXN of the SLM cards pass via the bus distributors BX0, . . . , BXk which combine and regenerate the signals, guided to a PCM bus pb of the central processing unit DC as signals dx′ (see transmitting components XS). Conversely, (see receiving components RS) a signal derived from a PCM signal pb′ and directed to the peripheral components is guided as signals dr′ to the bus distributors BR0, . . . , BRk and from there distributed as 'data receive′ signals dr to the receiving parts SRA, . . . , SRN of the SLM cards. The data processing in the SLM cards is based, for example, on a clock ck4 with 4.096 Mbit/s corresponding to a bit spacing t4 of 244 ns (compare FIG. 2) whereas, in the central processing unit DEC, a PCM bus according to the concept of the invention is operated at a higher data rate than the SLM cards, for example based on a 8.192 Mbit/s clock ck8.

As in known DLUs, the data transmission in the DLU D1 shown takes place via the PCM bus of the central processing unit DC through the use of a signal pb in the form of time-division multiplex frames TFR having a predetermined time period of e.g. 125 μs, each SLM card being allocated one channel with 64 kbit/s. In the figures, especially in FIG. 2, the channels allocated to the SLM transmitting parts SXA-SXN, and their signals, are designated by the reference symbols CHA-CHN or, respectively, cha-chn, where identical letters (A,B, C,D, . . . , M,N) identify corresponding components or signals. For each channel, one bit octet b7, b6, b5, . . . , b0 is transmitted in in each case one frame TFR as is shown in FIG. 2 by way of example through the use of the channel CHA or, respectively, its signal cha. In the exemplary embodiment shown, the digital signals are implemented e.g. by Low levels of 0 V (ground) and High levels at a voltage U_{S}.

In the example shown here, duplication of the clock rate ck8 of the PCM bus compared with the original clock rate ck4 achieves a doubling of the number of the useable channels so that up to 128 channels are now available. According to the invention, the bit octets are transmitted “interleaved” in groups which is shown by way of example in FIG. 2. In the example shown here, two octets are in each case interleaved as is shown in FIG. 2 with the example of signals cha, chb of channels CHA, CHB. These two channels form a group GAB where, according to the invention, the octets of in each case one group are transmitted time-interleaved instead of by themselves and one octet after the other in a known manner, in the time-division multiplex signal pb. In this configuration, there is in each case one bit of each of the remaining multiplets of the group—in the present example bit b7 of channel CHB between each two bits of an octet—for example between bits b7 and b6 of the channel CHA. After the transmission of the total of 2×8=16 bits of this group, the bits of the next group GCD are transmitted which, according to the invention, are formed of the interleaved octets of the channels CHC and CHD, etc. The bits in the signal bp of the PCM bus ZB are thus transmitted on the basis of the “fast” clock ck8, the data bits following one another at a clock period t8 of 122 ns. In contrast, the data processing in the SLM cards takes place on the basis of the “slow” clock ck4 or, respectively, a clock ck4′ derived therefrom, which is why the validity period of the bits of the transmitting parts SXA, . . . , SXN and of the receiving parts SRA, . . . , SRN of the SLM cards corresponds to the bit period t4 of this latter clock, thus 244 ns in the present example.

In general, more than two channels, e.g. four, six, eight, etc. can also belong to a group; in each case, it would be, for example, bits b7 of the channels of one group which would be transmitted, then bits b6, and so forth. In addition, the invention is not restricted to one octet being transmitted in each case; instead, a data multiplet formed of n bits can just as well be allocated to each channel where n can assume any values from 4, e.g. n=4, 6, 10 or 16. Also, instead of a binary coding of the data bits, a multiplet of digital data coded in a non-binary form, e.g. characters coded via predetermined discrete levels, can be used in the multiplets.

Due to this time-interleaved transmission of the bits of a group, the transmitting and receiving parts only need to generate or, respectively, receive each second bit—or, respectively, each fourth, sixth, eighth, etc. bit in dependence on the number of channels in a group—of the frame TFR transmitted with the signal bp. This results in a data processing rate which is reduced compared with the data rate of the PCM bus for the SLM card. Each SLM card can thus operate at a lower clock rate. It is possible to use, e.g. the “fast” clock ck8 through the use of a suitably selected clock division for this purpose.

In the SLM cards, a “slower” clock ck4 is advantageously used, one channel of a group being clocked, e.g., through the use of rising edges of the clock ck4 and the other channel being clocked through the use of falling edges. It is thus not necessary to distribute the “fast” clock ck8 to the SLM cards but the clock ck4 is sufficient if it meets the requirements of a clock signal with regards to its symmetry and the characteristics of both types of edges which is easily possible through the use of known components. The clock ck4 can be derived, for example, from the clock ck8 in the central controller of the DLU and conducted to the SLM cards via the distribution system provided in a known manner. Using the slower clock ck4 in the SLM cards and in the distribution system facilitates, as a further advantage of the invention, the reduction of electromagnetic disturbances which are caused by fast or rapidly alternating signals.

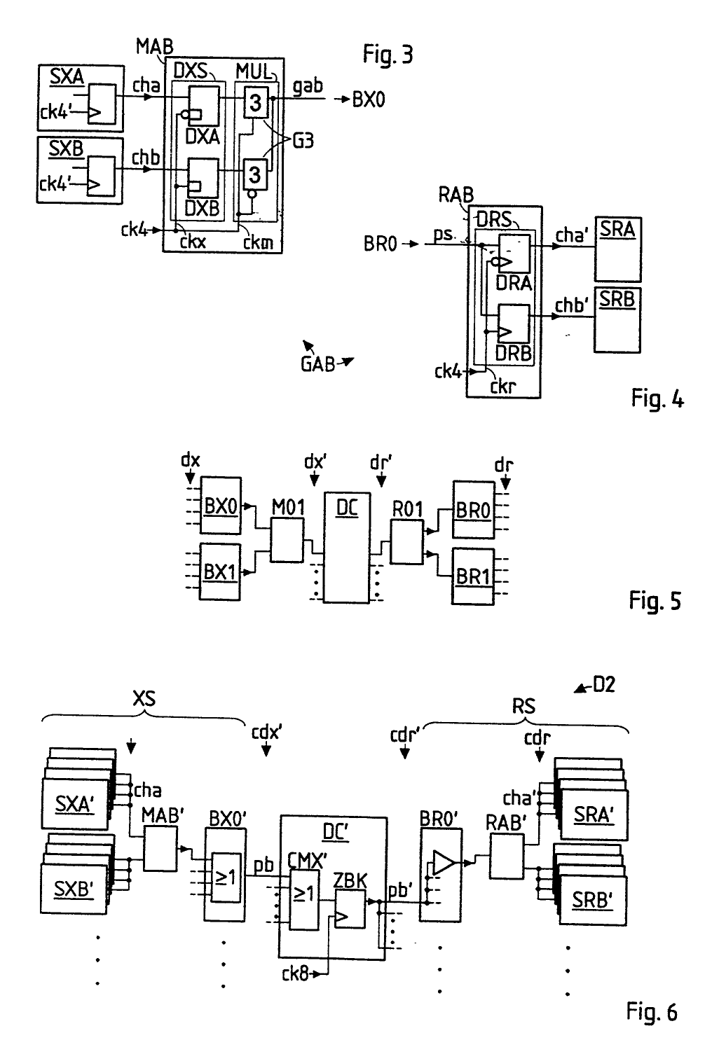

FIG. 3 shows the configuration of a possible group circuit MAB for generating the time-division multiplex signal according to the invention on the basis of the signals cha, chb of the transmitting parts SXA, SXB for the group GAB of FIG. 1. The transmitting parts SXA, SXB generate their burst signals cha, chb as 'data transmit′ signals based on the ck4 clock. In the example shown here, the second burst signal chb is generated synchronously with the first burst signal cha (FIG. 2) but it can also be shifted in phase with respect to the first signal chb, namely by up to a clock period t8 of the ck8 clock, corresponding to one half of the clock period t4.

The group circuit MAB exhibits one D-type register DXA, DXB followed by a tristate gate G3 in each case for both burst signals cha, chb. The first signal cha is stored in the D-type register DXA which becomes active in the Low phase of the clock ck4 used as drive signal ckx, and switched to the output gab with the High phase of the clock signal in the subsequent clock half via the associated tristate gate. Conversely, the D-type register DXB allocated to the second signal chb becomes active in the High phase and the signal thus temporarily stored is forwarded to the output gab by the associated tristate gate with the following Low phase of the clock signal.

The two tristate gates G3 thus form a group multiplexer MUL for the group output signal gab. The drive signal ckx of the latch device DRS formed by latches DXA, DXB and the drive signal ckm of the group multiplexer MUL do not need to have been obtained directly from the clock ck4 but can have a predetermined phase shift applied to them, for example, if necessary, for example with the aid of phase shifter elements in order to be able to compensate for delay changes in the signals in this manner; for example, this makes it possible for the gates of the group multiplexer MUL to be triggered later than the D-type registers of the latch device DRS by less than one half clock period.

The output signals gab, . . . , gmn of the various groups GAB, . . . , GMN are combined in a known manner and supplied to the PCM bus of the central processing unit DC. The collecting system of the PCM bus used for this purpose is used as common multiplexer device which is implemented by the bus distributor transmitting parts BX0, . . . , BXk and the multiplexer stage CMX of the central processing unit.

At the receiving end, the signal pb′ of the PCM bus is supplied to the receiving parts of the SLM via distributor device of the central processing unit DC and the bus distributors BR0, . . . , BRk. Referring to FIG. 4, a group circuit RAB is allocated to the receiving parts SRA, SRB of group GAB. In this circuit, a D-type register DRA, DRB is in each case provided for each receiving part, through the use of which register the group signal is divided into the two channel signals cha′, chb′. In the embodiment shown in FIG. 4, the D-type registers are driven with the “slow” clock ck4 and implemented as edge-controlled registers, the first D-type register DRA being driven through the use of a falling edge and the second D-type register DRB being driven through the use of a rising edge. The drive ckr of the receiving group circuits RAB can also be implemented through the use of the clock ck8, then the two channel signals cha′, chb′ are driven with the falling edge but alternating with each second edge of the clock signal ck8. In FIG. 2, only the signal cha′ allocated to the first SLM receiving part SRA is shown for the sake of clarity.

In the latch device DXS, it would also be possible to operate with edge-controlled D-type registers instead of level-controlled latches DXA, DXB; in this case, the first D-type register DXA would be driven through the use of a falling edge and the second D-type register DXB would be driven through the use of a rising edge of the drive signal ckx similarly to the latch device DRS of the receiving end. In the latch device DRS, in contrast, triggering is advantageously done with the edges of the clock signal since otherwise transient processes of the incoming group signal could disturb the signal already accepted.

In the exemplary embodiment shown in FIGS. 1-4, the group circuits are provided in the signal paths of the signals dx and dr of the decentralized SLM components, thus transmitting group circuits MAB, . . . , MMN preceding the bus distributor transmitting parts BX0, . . . , BXk and receiving group circuits RAB, . . . , RMN following the bus distributor receiving parts BR0, . . . , BRk (“decentralized group circuits”). However, it is also possible to provide, as shown by way of example in FIG. 5, “intermediate-level” group circuits M01, R01 in the signal paths dx′ and dr′ between the bus distributors BX0, BX1 or, respectively, BR0, BR1, and the central processing unit DC. In FIG. 5, the decentralized components are not shown for the sake of clarity. Intermediate-level group circuits can be set up instead of or additionally to decentralized group circuits. The circuit configuration of the intermediate-level group circuits M01 and R01 can be implemented, e.g., like the group circuits MAB and RAB of FIGS. 3 and 4, respectively.

The invention is also suitable for signals of the collision detection bus. The implementation of the invention for the collision detection bus essentially builds on what has been said above with respect to the PCM bus which is why the representation relating to FIGS. 2-5 is incorporated in the text which follows and only a few points are added; however, the collision detection bus replaces the PCM bus dealt with in FIG. 1 as central system bus as shown in FIG. 6.

Analogously to the DLU D1 of FIG. 1, the DLU D2 of FIG. 6 also exhibits in this exemplary embodiment a central part DC′, a number of bus distributors and a number of SLM cards; for the sake of clarity, FIG. 6 only shows the components associated with group GAB. The transmitting parts SXA′, SXB′ of the SLM cards and the transmitting part BX0′ of the bus distributor are again shown on the left-hand side (transmitting components XS) and the corresponding receiving parts BRO′ and SRA′, SRB′ are shown on the right-hand side. According to the invention, the DLU D2 of FIG. 6 exhibits group circuits MAB′, RAB′ which produce the interleaving of the signals cdx in accordance with the invention.

In addition, the outputs of a number of transmitting parts and correspondingly the inputs of a number of receiving parts can be combined directly on a common output line or fanned out from a common input line in accordance with the collision detection principle as is shown in the example of the decentralized components SXA′, SRA′, SXB′, SRB′ in FIG. 6.

The implementation of the collision detection principle requires that the signal sent out by a decentralized component—in the present case, e.g. signals cha, chb—are conducted as CDX signals cdx via the collision detection bus to the central point of the DLU and from there as CDR signal cdr signals cha′, chb′ in the example—back to the relevant decentralized component again, where it is checked as long as the relevant bit of the CDX signal is still valid. For the rest, the group circuits MAB′, RAB′ of the present exemplary embodiment correspond to those MAB, RAB of FIGS. 1-4; in addition, decentralized group circuits can also be provided here as discussed above with reference to the example of FIG. 5.

Since the total delay of the signal, namely as CDX signal from the SLM card SXA′ and SXB′, respectively, via the bus distributor BXO′ (in each case transmitting parts) to the central part DC′ and from there back as CDR signal via the bus distributor BRO′ to the relevant SLM card SRA′ and SRB′, respectively, (in each case receiving parts) can be greater than one clock period t8, an additional clocking through the use of a flipflop ZBK is advantageously provided in the central processing unit DC′. This eliminates any disturbance which could result from the “later” channel CHB having a “faster” signal path and can therefore “pass” the other channel of its group, in this case, therefore, channel CHB.

Since, according to the invention, a data bit of the signal cha in a decentralized component is valid for the clock period t4 of the clock ck4, the signal conducted back by the collision detection bus only needs to reach the decentralized component shortly before this time has elapsed. The invention thus allows the slower clock ck4 of the decentralized components to be used as a basis, instead of the bus clock ck8, in the configuration of the delays of the signals running via the bus. Thus, almost one half of the clock period t4 that is to say almost 122 ns—are available to the CDX signal on the path to the central flipflop ZBK. The signal is forwarded to the receiving stages with the next edge of the clock ck8; for the path to the receiving parts of the decentralized component, almost one half of the clock period t4 is again available.

As already mentioned, the invention is not restricted to the case where the data multiplets of in each case two channels are transmitted interleaved with one another in a group. Instead, this can also be performed for, e.g., four or more channels. If, for example starting with the example shown in FIG. 1, four channels per group are transmitted—that is to say first bit 7 of channels CHA, CHB, CHC, CHD, then bit 6 of these channels and so forth, that is to say a total of 4×8=32 bits per group—the required processing speed in the central components would be reduced to one half as a result, the data rate of the central bus system remaining the same, and similarly that for weighting bit collisions on the collision detection bus would be almost doubled correspondingly.

I claim:

1. A method for transmitting data bits, the method which comprises:
allocating data bits to a plurality of channels;
providing a given time sequence in time-division multiplex frames for transmitting the data bits with a given data rate on a transmission path, the time-division multiplex frames each containing a plurality of multiplets such that for each of the channels a respective one of the multiplets includes a given number of the data bits; and
transmitting, in the time-division multiplex frames, in accordance with a given allocation of the channels to groups each including a subset of the channels, the multiplets of each of the groups in a time-interleaved manner such that between respective two of the data bits of one of the multiplets of a given one of the groups there is a respective one of the data bits of each remaining one of the multiplets of the given one of the groups and such that the groups are transmitted sequentially.

2. The method according to claim 1, which comprises:
providing a clock signal having a clock rate corresponding to the given data rate divided by a number of the channels allocated to the subset;
clocking a transmission of the data bits with the clock signal; and
triggering the clocking of the transmission of the data bits in each of the groups of successive ones of the multiplets with a mutual offset by one clock unit corresponding to the data rate.

3. The method according to claim 2, which comprises:
grouping the channels in pairs, each of the pairs including a first channel and a second channel;
clocking the data bits of the first channel in each of the groups with a first half of the clock unit; and
clocking the data bits of the second channel in each of the groups with a second half of the clock unit.

4. The method according to claim 2, which comprises:
grouping the channels in channel pairs, each of the cannel pairs including a first channel and a second channel; and
clocking the data bits of associated ones of the multiplets of the first channel in each of the groups with a first half of the clock unit; and
clocking the data bits of associated ones of the multiplets of the second channel in each of the groups with a second half of the clock unit.

5. The method according to claim 1, which comprises transmitting the data bits on a PCM bus in octets each including eight of the data bits.

6. The method according to claim 1, which comprises:
transmitting the data bits on a collision bus; and
additionally clocking, with a central component, a signal of the collision bus with a bus clock corresponding to the given data rate.

7. A device for generating time-division multiplex signals, comprising:
a plurality of latches, said latches receiving burst signals, the burst signals being allocated to groups each including a respective number of the burst signals, the burst signals containing respective data bit multiplets within a period of time-division multiplex frames with a given data rate, each of the data bit multiplets including a given number of data bits;
said latches being configured such that given ones of said latches allocated to one of the groups are driven in a time-shifted manner with a relative time offset with respect to one another for a time-interleaved transmission of the data bit multiplets of the burst signals, the relative time offset of said given ones of said latches within the one of the groups being smaller than a time interval between two of the data bits of one of the multiplets;
a common multiplexer; and
said latches having outputs connected to said common multiplexer.

8. The device according to claim 7, wherein:
said latches, within a given one of the groups, are clocked by a common clock signal with a clock rate corresponding to the given data rate divided by a number of the burst signals of the given one of the groups; and
said latches allocated to successive ones of the burst signals in the given one of the groups are triggered with a mutual offset by a clock period corresponding to the given data rate.

9. The device according to claim 8, wherein:
said latches are configured for processing respective two of the burst signals in each of the groups; and
a first one of said latches in each of the groups is clocked by a first half of the clock period and another one of said latches is clocked by a second half of the clock period.

10. The device according to claim 7, wherein:
said common multiplexer includes a plurality of common group multiplexers having group multiplexer outputs;
a multiplexing device connected to said common group multiplexers;
said outputs of said latches of each one of the groups are connected to a respective one of said common group multiplexers; and
said latches are clocked by a clock signal and are configured such that signals at said outputs of said latches are released by the clock signal.

11. A device for obtaining burst signals from a time-division multiplex signal, comprising:
a plurality of latches, said latches receiving a time-division multiplex signal including, within time-division multiplex frames, data bits with a given data rate, the time-division multiplex frames containing a plurality of multiplets such that the multiplets are provided for respective ones of a plurality of burst signals, the burst signals being allocated to groups each including a number of the burst signals, and each of the multiplets including a given number of the data bits;
a respective one of said latches being allocated to a respective one of the burst signals; and
respective ones of said latches allocated to in each case one of the groups being driven with a mutual time offset with respect to one another such that, between driving two of the data bits of a given one of the multiplets of a given one of the groups, one of the data bits of each remaining one of the multiplets of the given one of the groups is driven.

12. The device according to claim 11, wherein:
said latches, within a given one of the groups, are clocked by a common clock signal with a clock rate corresponding to the given data rate divided by a number of the burst signals of the given one of the groups; and
said latches allocated to successive ones of the burst signals in the given one of the groups are triggered offset with respect to one another by a clock period corresponding to the given data rate.

13. The device according to claim 12, wherein:
said latches are configured for processing respective two of the burst signals in each of the groups; and
a first one of said latches in each of the groups is clocked by a first half of the clock period and a second one of said latches is clocked by a second half of the clock period.
